(19) United States
(12) Patent Application Publication
(10) Pub. No.: US 2025/0139821 A1
(43) Pub. Date: May 1, 2025

(54) METHOD AND APPARATUS FOR DETERMINING THREE-DIMENSIONAL LAYOUT INFORMATION, DEVICE, AND STORAGE MEDIUM

(71) Applicant: Tencent Technology (Shenzhen) Company Limited, Shenzhen (CN)

(72) Inventors: Weizhe LIU, Shenzhen (CN); Pan JI, Shenzhen (CN); Hongdong Li, Shenzhen (CN)

(21) Appl. No.: 19/008,306

(22) Filed: Jan. 2, 2025

Related U.S. Application Data
(63) Continuation of application No. PCT/CN2023/129245, filed on Nov. 2, 2023.

(30) Foreign Application Priority Data
Jan. 12, 2023 (CN) 202310070284.0

(51) Int. Cl. G06T 7/73; G06T 5/50; G06T 17/00

(52) U.S. Cl. CPC G06T 7/73; G06T 5/50; G06T 17/00; G06T 2207/20084; G06T 2207/20221

(57) ABSTRACT

This application relates to a method and an apparatus for determining three-dimensional layout information. The foregoing method includes: obtaining a first image and a second image obtained by photographing a same 3D region by a first camera and a second camera simultaneously; and generating three-dimensional layout information of the 3D region based on a relative position between the first camera and the second camera, a photographing parameter of each of the first camera and the second camera, the first image, and the second image, the three-dimensional layout information being configured for characterizing a three-dimensional spatial layout of at least one real object in the 3D region. The foregoing method can improve accuracy of layout information of the 3D region.

### CROSS-REFERENCE TO RELATED APPLICATIONS

This application is a continuation application of PCT Patent Application No. PCT/CN2023/129245, entitled “METHOD AND APPARATUS FOR DETERMINING THREE-DIMENSIONAL LAYOUT INFORMATION, DEVICE, AND STORAGE MEDIUM” filed on Nov. 2, 2023, which claims priority to Chinese Patent Application No. 202310070284.0, “METHOD AND APPARATUS FOR DETERMINING THREE-DIMENSIONAL LAYOUT INFORMATION, DEVICE, AND STORAGE MEDIUM” filed on Jan. 12, 2023, both of which are incorporated herein by reference in their entirety.

### FIELD OF THE TECHNOLOGY

Embodiments of this application relate to the field of image processing technologies, and in particular, to a method and an apparatus for determining three-dimensional layout information, a device, and a storage medium.

### BACKGROUND OF THE DISCLOSURE

Room layout estimation is a technology for determining layout information of a room, which may be configured for implementing a technology such as extended reality (XR).

In the related art, layout information of a room is determined based on a room image captured by a monocular camera. However, the layout information of the room obtained in this way is two-dimensional, which is different from a room layout in an actual three-dimensional space, and the layout information is not accurate enough.

### SUMMARY

Embodiments of this application provide a method and an apparatus for determining three-dimensional layout information, a device, and a storage medium, which can improve accuracy of layout information of a 3D region. The technical solutions are as follows.

According to an aspect of the embodiments of this application, a method for determining three-dimensional layout information is performed by a computer device and including:
obtaining a first image and a second image of a 3D region using a first camera and a second camera simultaneously; and
generating three-dimensional layout information of the 3D region based on a relative position between the first camera and the second camera, a photographing parameter of each of the first camera and the second camera, the first image, and the second image, the three-dimensional layout information being configured for characterizing a three-dimensional spatial layout of at least one real object in the 3D region.

In some embodiments, the generating three-dimensional layout information of the 3D region based on a relative position between the first camera and the second camera, a photographing parameter of each of the first camera and the second camera, the first image, and the second image includes:
generating an image feature of the first image and an image feature of the second image;
fusing the image feature of the first image and the image feature of the second image based on the relative position between the first camera and the second camera and the photographing parameter of each of the first camera and the second camera, to generate a three-dimensional feature of the 3D region, the three-dimensional feature being configured for characterizing spatial information of the 3D region; and
generating the three-dimensional layout information of the 3D region based on the three-dimensional feature of the 3D region.

In some embodiments, the three-dimensional layout information is obtained by a three-dimensional layout estimation model, the three-dimensional layout estimation model including a neural network encoder, a three-dimensional feature fuser, and a neural network decoder;
the neural network encoder being configured to generate the image feature of the first image and the image feature of the second image;
the three-dimensional feature fuser being configured to fuse the image feature of the first image and the image feature of the second image based on the relative position between the first camera and the second camera and the photographing parameter of each of the first camera and the second camera, to generate the three-dimensional feature of the 3D region; and
the neural network decoder being configured to generate the three-dimensional layout information of the 3D region based on the three-dimensional feature of the 3D region.

In some embodiments, the three-dimensional feature fuser includes a first neural network and a second neural network, the first neural network being a neural network designed based on a binocular disparity estimation principle, and the second neural network being a recurrent neural network;
the first neural network being configured to fuse the image feature of the first image and the image feature of the second image to generate a fused feature of the first image and the second image, the fused feature of the first image and the second image being configured for comprehensively characterizing the first image and the second image; and the second neural network being configured to generate the three-dimensional feature of the 3D region based on the fused feature of the first image and the second image.

In some embodiments, the three-dimensional layout information of the 3D region includes three-dimensional pose information and annotation information of the at least one real object in the 3D region.

In some embodiments, the first camera and the second camera are arranged on a same device, and the relative positions of the first camera and the second camera are fixed.

In some embodiments, the device is a head-mounted display device; and the method further includes:
constructing a virtual scene or a virtual object adapted to the 3D region based on the three-dimensional layout information; and
displaying the virtual scene or the virtual object in the 3D region.

In some embodiments, the relative position includes a distance, and the photographing parameter includes a focal length.

According to an aspect of the embodiments of this application, a computer device is provided, including a processor and a memory, the memory having computer programs stored therein, the computer programs, when executed by the processor, causing the computer device to implement the foregoing method for determining three-dimensional layout information.

According to an aspect of the embodiments of this application, a non-transitory computer-readable storage medium is provided, having computer programs stored therein, the computer programs, when executed by a processor of a computer device, causing the computer device to implement the foregoing method for determining three-dimensional layout information.

The technical solutions provided in the embodiments of this application may include the following beneficial effects.

The same 3D region is photographed at the same time by using the first camera and the second camera, to obtain images of the same 3D region photographed from two different angles at the same time. To be specific, the images of the 3D region are obtained through a binocular camera, and a three-dimensional spatial layout of an object in the 3D region is determined based on the images. Compared with two-dimensional layout information, the accuracy of the layout information of the 3D region is improved.

The foregoing general descriptions and the following detailed descriptions are exemplary and explanatory only and are not intended to limit this application.

### BRIEF DESCRIPTION OF THE DRAWINGS

FIG. 1 is a schematic diagram of a method for determining three-dimensional layout information according to an embodiment of this application.

FIG. 2 is a schematic diagram of a head-mounted display device according to an embodiment of this application.

FIG. 3 is a schematic diagram of an implementation environment according to an embodiment of this application.

FIG. 4 is a flowchart of a method for determining three-dimensional layout information according to an embodiment of this application.

FIG. 5 is a schematic diagram of a 3D region according to an embodiment of this application.

FIG. 6 is a schematic diagram of a three-dimensional layout estimation model according to an embodiment of this application.

FIG. 7 is a schematic diagram of a binocular disparity estimation principle according to an embodiment of this application.

FIG. 8 is a block diagram of an apparatus for determining three-dimensional layout information according to an embodiment of this application.

FIG. 9 is a block diagram of a computer device according to an embodiment of this application.

### DESCRIPTION OF EMBODIMENTS

Exemplary embodiments are to be described herein in detail, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with this application. On the contrary, the implementations are merely examples of a method which are consistent with some aspects of this application described in detail in the attached claims.

According to this application, a prompt interface and a pop-up window may be displayed or voice prompt information is outputted before relevant data (for example, a first image and a second image mentioned in this application) of a user is collected and during collection of relevant data of the user. The prompt interface, the pop-up window, or the voice prompt information is configured for prompting the user that relevant data of the user is being collected currently, so that this application starts to perform the relevant operations of obtaining user-related data only after obtaining a confirm operation performed by the user on the prompt interface or the pop-up window, or otherwise (i.e., when the confirm operation performed by the user on the prompt interface or the pop-up window has not been obtained), the relevant operations of obtaining user-related data are ended, i.e., the user-related data is not obtained. In other words, all user data collected in this application is collected with the consent and authorization of users, and the collection, use, and processing of relevant user data need to comply with relevant laws, regulations, and standards of relevant countries and regions.

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and involves a wide range of fields including both the hardware-level technology and the software-level technology. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

CV is a field of science that studies how to use a machine to “see”, and furthermore, that uses a camera and a computer device to replace human eyes to perform machine vision such as recognition and measurement on a target, and further perform graphic processing, so that the computer device processes the target into an image more suitable for human eyes to observe, or an image transmitted to an instrument for detection. As a scientific discipline, CV studies related theories and technologies and attempts to establish an AI system that can obtain information from images or multidimensional data. The CV technology generally includes technologies such as image processing, image recognition, image semantic understanding, image retrieval, optical character recognition (OCR), video processing, video semantic understanding, video content/behavior recognition, three-dimensional object reconstruction, three-dimensional technology, virtual reality (VR), augmented reality (AR), and simultaneous localization and mapping, and further includes common biometric recognition technologies such as face recognition and fingerprint recognition.

Machine learning (ML) is a multi-field interdiscipline, and relates to a plurality of disciplines such as the probability theory, statistics, the approximation theory, convex analysis, and the algorithm complexity theory. The ML specializes in studying how a computer simulates or implements a learning behavior of human to obtain new knowledge or skills and reorganize an existing knowledge structure to keep improving its performance. The ML is the core of the AI and a fundamental way to make computers intelligent, which is applied in all fields of the AI. The ML and the deep learning generally include technologies such as an artificial neural network, a confidence network, reinforcement learning, transfer learning, inductive learning, and learning from demonstration.

With the research and progress of AI technologies, the AI technology has been researched and applied in many fields, such as a common smart wearable device, a smart home, a virtual assistant, a smart speaker, smart marketing, unmanned driving, automatic driving, an unmanned aerial vehicle, a robot, smart medical care, smart customer service, and the like. It is believed that with the development of technologies, the AI technology is to be applied in more fields and plays increasingly important value.

The solutions provided in the embodiments of this application involve the technologies such as the CV and the ML of the AI. For example, an image captured by a binocular camera is processed through the CV technology. For another example, a three-dimensional layout estimation model is trained through the ML technology, and three-dimensional layout information of a 3D region is generated by the three-dimensional layout estimation model. Embodiments of this application may be applied to the field of extended reality (XR). For example, when a user wears a head-mounted display device in a room and an XR application is running in the head-mounted display device, the head-mounted display device may capture a picture of the room and generate three-dimensional layout information of a 3D region, which is convenient for the user to experience XR safely. The XR refers to creating a digital environment with a combination of a real world and a virtual world through modern scientific and technological means with a computer device as the core, which is a new-type human-computer interaction mode, and may bring users a sense of immersion of seamless transition and connection between the virtual world and the real world. The XR technology may specifically include AR, VR, mixed reality (MR), and the like. The technologies are specifically described through the following embodiments.

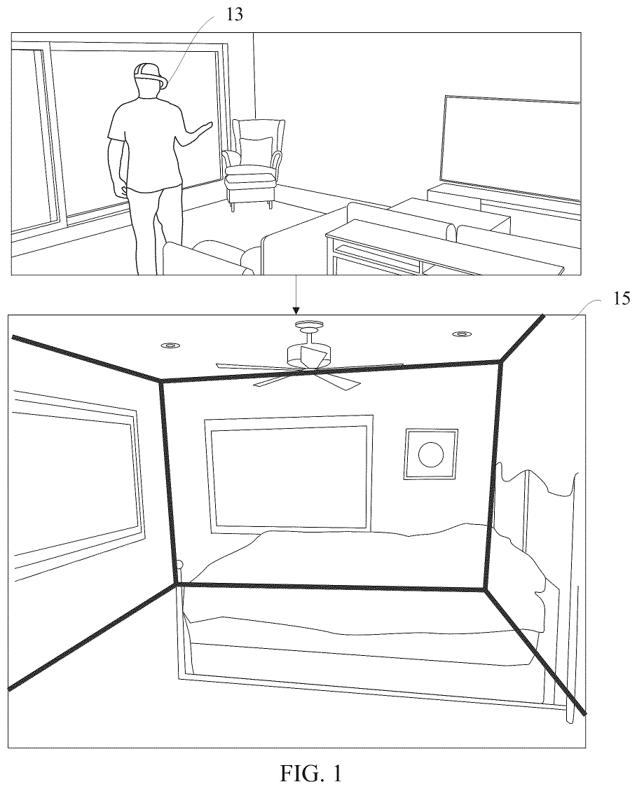

FIG. 1 is a schematic diagram of a method for determining three-dimensional layout information according to an embodiment of this application. As shown in FIG. 1, a user obtains two images (which may be referred to as a first image and a second image) of a room through a head-mounted display device 13. The two images are obtained by photographing a same region of the room simultaneously respectively by two cameras (which may be referred to as a first camera and a second camera) integrated in the head-mounted display device 13. The first image and the second image are inputted into a three-dimensional layout estimation model, and the three-dimensional layout estimation model may generate and output a three-dimensional layout diagram 15 of the room. The three-dimensional layout diagram includes at least one annotation box (a box surrounded by bold lines in FIG. 1), which is configured to represent a frame part of the room, such as an annotation box corresponding to the ceiling of the room, an annotation box corresponding to the floor, and an annotation box corresponding to a left wall. In some embodiments, different annotation boxes in the three-dimensional layout diagram are displayed differently, such as displayed in different colors. For another example, the three-dimensional layout diagram is annotated with names of room regions corresponding to the annotation boxes, such as “ceiling”, “floor”, “left wall”, and “right wall”.

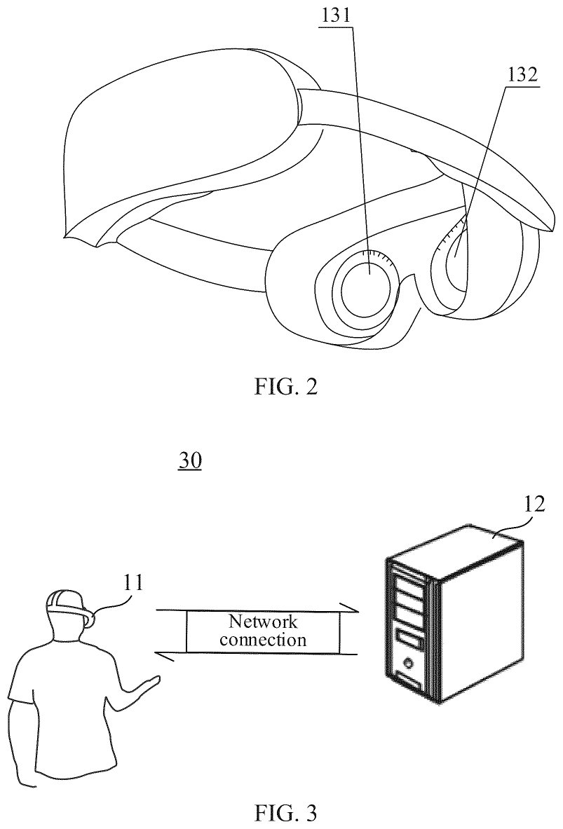

In some embodiments, as shown in FIG. 2, the first camera 131 and the second camera 132 in the head-mounted display device 13 are respectively located on two sides of the head-mounted display device 13. When a user wears the head-mounted display device, the first camera 131 is located in front of a left eye of a user, and the second camera 132 is located in front of a right eye of the user. Therefore, the first camera 131 may also be referred to as a left camera, and the second camera 132 may also be referred to as a right camera. In some embodiments, the first camera and the second camera may be infrared cameras, which can perform photographing in a dark environment.

In this embodiment of this application, three-dimensional layout information of a room is obtained through the head-mounted display device, which is helpful to display a virtual picture in an appropriate region of the room. For example, a virtual scene is displayed on a real wall and just covers the entire wall, thereby improving a sense of reality of the virtual scene, and improving user experience of an XR picture, an XR game, and the like.

In addition, when the user moves in the room while wearing the head-mounted display device, the head-mounted display device can identify a three-dimensional layout diagram of the room, and may prompt the user to avoid an obstacle by transmitting prompt information to the user, to prevent the user from getting into danger and improve safety of the user.

FIG. 3 is a schematic diagram of an implementation environment according to an embodiment of this application. The implementation environment may be implemented as an interactive animation playback system. As shown in FIG. 3, the system 30 may include a terminal device 11 and a server 12.

A target application, such as a client of the target application, is installed and run in the terminal device 11. The terminal device is an electronic device having data calculation, processing, and storage capabilities. The terminal device may be a wearable device, such as a head-mounted display device, smart glasses, and XR glasses. The XR glasses may include AR glasses, MR glasses, VR glasses, and the like. The terminal device may further be a handheld scanner, a smartphone, a tablet computer, a personal computer (PC), or the like. This is not limited in the embodiments of this application. The target application may be any application having a function of determining three-dimensional layout information, such as an image processing application, a projection application, a social application, a payment application, a video application, a music application, a shopping application, or a news application. According to the method provided in the embodiments of this application, each operation may be performed by the terminal device 11, such as a client running in the terminal device 11.

In some embodiments, the system 30 further includes a server 12. The server 12 establishes a communication connection (such as a network connection) with the terminal device 11. The server 12 is configured to provide a background service for the target application. The server may be an independent physical server, or may be a server cluster composed of a plurality of physical servers or a distributed system, and may further be a cloud server providing a cloud computing service.

In the method provided in the embodiments of this application, each operation may be performed by a computer device. The computer device refers to an electronic device having data computing, processing, and storage capabilities. The computer device may be the terminal device 11 in FIG. 3, or may be the server 12.

The technical solutions of this application are described below through several embodiments.

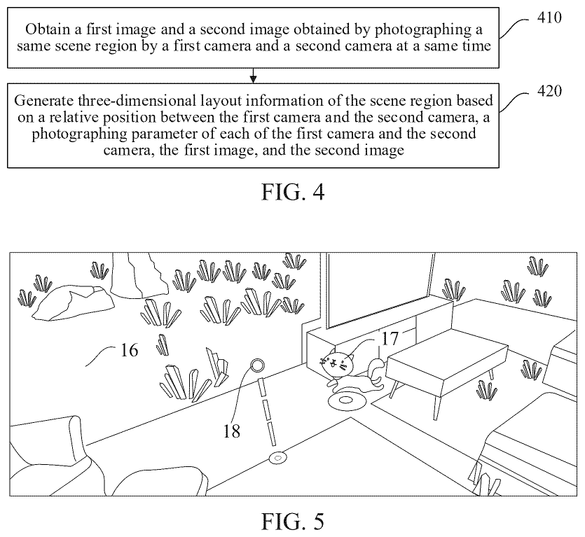

FIG. 4 is a flowchart of a method for determining three-dimensional layout information according to an embodiment of this application. In this embodiment, an example in which the method is applied to the computer device described above is used for description. The method may include at least one of the following operations (410-420).

Operation 410: Obtain a first image and a second image obtained by photographing a same 3D region by a first camera and a second camera simultaneously.

In some embodiments, the first camera and the second camera photograph the same 3D region at the same time and in different positions, so as to obtain the first image and the second image respectively. To be specific, the first image and the second image are images of the 3D region captured at different angles. The first image is captured by the first camera, and the second image is captured by the second camera.

In some embodiments, the 3D region may refer to a partial region or an entire region of a scene. For example, the 3D region may refer to an entire room, or may also refer to a partial region of the room, such as an entrance region of the room, a southeast corner of the room, or an eastern region of the room. This is not specifically limited in the embodiments of this application. A scene may refer to a room, a warehouse, a stadium, a road, a garden, a park, a cockpit, or the like. This is not specifically limited in the embodiments of this application.

In some embodiments, the first camera and the second camera are arranged on the same device, and the relative positions of the first camera and the second camera are fixed. In some embodiments, the relative positions of the first camera and the second camera are fixed during photographing of the same scene. During photographing of different scenes, the relative positions of the first camera and the second camera may be the same or different. The relative positions of the first camera and the second camera may include a distance and a relative direction between the two cameras. In some embodiments, the distance and the relative direction between the first camera and the second camera are adjustable. For example, the distance between the first camera and the second camera may be increased or shortened. For another example, in a case that one of the first camera and the second camera is at a higher position than the other, the first camera and the second camera may be adjusted to the same height by adjusting a height of the first camera and/or the second camera. In some embodiments, a scale or other prompt information exists and may be displayed on the device, to prompt the distance and the relative direction between the first camera and the second camera.

In some embodiments, the device may automatically generate, based on a size of the 3D region, recommended information including recommended relative positions of the first camera and the second camera, and transmit the recommended information to a user. In this way, time required for the user to adjust the relative positions of the first camera and the second camera is reduced, thereby improving use convenience of the device.

In some embodiments, the device may be a head-mounted display device, such as XR glasses or smart glasses.

In some embodiments, image parameters of the first image and the second image are the same. For example, image resolutions of the first image and the second image are the same. For another example, shapes and sizes of the first image and the second image are the same. In some embodiments, photographing parameters such as camera types and focal lengths respectively corresponding to the first image and the second image are also the same. Therefore, feature fusion of the two images is facilitated, thereby improving accuracy of fused three-dimensional features, and further improving the accuracy of the three-dimensional layout information.

In some embodiments, the first image and the second image are in the same file format. The file format of the first image and the second image may be JPEG, TIFF, RAW, PNG, BMP, EXIF, or the like. This is not specifically limited in the embodiments of this application.

Operation 420: Generate three-dimensional layout information of the 3D region based on a relative position between the first camera and the second camera, a photographing parameter of each of the first camera and the second camera, the first image, and the second image.

In some embodiments, the three-dimensional layout information is configured for characterizing a three-dimensional spatial layout of at least one real object in a 3D region. In some embodiments, the three-dimensional layout information is configured for characterizing a three-dimensional spatial layout of a part or an entirety of the real object in the 3D region. For example, in a case that the 3D region is a partial region of a room, three-dimensional layout information may be configured for characterizing a three-dimensional spatial layout of a room frame of the room, such as the three-dimensional spatial layout of a ceiling, a wall, and a floor. In some embodiments, the three-dimensional layout information may also be configured for characterizing a three-dimensional spatial layout of objects such as a sofa, a coffee table, and a ceiling fan in a room.

The three-dimensional layout information includes a position parameter and a size parameter of at least one real object in the 3D region. In some embodiments, the 3D region corresponds to a spatial coordinate system, and a position of a real object in the 3D region may be expressed as spatial coordinates of a feature point (such as a central point or a corner point) of the object in the spatial coordinate system. In some embodiments, in a case that the 3D region is a room, an origin of the spatial coordinate system may be located in a center of the room, or may be located in a central position of the floor of the room, and may further be located in a position of a top surface (such as the ceiling of the room) of the room. In some embodiments, in a case that a room includes a rectangular wall, the origin of the spatial coordinate system may further be located at a certain vertex of the rectangular wall, and two mutually perpendicular coordinate axes of the spatial coordinate system may be located on straight lines where two adjacent sides of the rectangular wall are located.

In some embodiments, the relative position includes a distance, and the photographing parameter includes a focal length. In some embodiments, the photographing parameters of the first camera and the second camera are the same. For example, the focal lengths of the first camera and the second camera are the same. In some embodiments, photographing parameters such as exposure compensation, aperture values, and shutter values of the first camera and the second camera are the same.

In some embodiments, the three-dimensional layout information of the 3D region includes three-dimensional pose information and annotation information of the at least one real object in the 3D region. The three-dimensional pose information of the real object in the 3D region includes a position and a posture of the real object in the 3D region. In some embodiments, the three-dimensional layout information of the 3D region is represented as a three-dimensional layout diagram of the 3D region. In some embodiments, the three-dimensional layout diagram includes at least one annotation box. The annotation box may be configured to represent a real object of a frame part of a 3D region, such as a ceiling, a floor, or a wall in a room. In some embodiments, the annotation information may include different annotation boxes annotated with different colors in the three-dimensional layout diagram. In some embodiments, the annotation information may include a text annotation of a real object in the three-dimensional layout diagram, such as a “ceiling”, a “floor”, a “left wall”, a “right wall”, a “sofa”, or a “table”. The real object is directly annotated in the three-dimensional layout diagram of the 3D region, so that the three-dimensional layout information is more vivid, and the user may visually, clearly, and conveniently learn a three-dimensional layout of the 3D region.

In some embodiments, the three-dimensional pose information of the real object in the 3D region may refer to a pose of the real object relative to the spatial coordinate system corresponding to the 3D region, or may also refer to a pose of the real object relative to a device where the first camera/the second camera/the first camera and the second camera are located. In some embodiments, the three-dimensional pose information of the real object in the 3D region includes an orientation of the foregoing annotation box/real object, such as an orientation of the annotation box/real object relative to the device where the first camera/the second camera/the first camera and the second camera are located. For example, if a certain annotation box represents a wall, three-dimensional pose information thereof includes a pose or an orientation of the annotation box/wall relative to the device where the first camera/the second camera/the first camera and the second camera are located. In some embodiments, the orientation includes directly opposite, upward, downward, leftward, rightward, and the like. In some embodiments, an annotation box may represent a junction between at least one real object in a 3D region.

In some embodiments, operation 420 may include the following operations:
1. generating an image feature of the first image and an image feature of the second image;
2. fusing the image feature of the first image and the image feature of the second image based on the relative position between the first camera and the second camera and the photographing parameter of each of the first camera and the second camera, to generate a three-dimensional feature of the 3D region, the three-dimensional feature being configured for characterizing spatial information of the 3D region; and
3. generating the three-dimensional layout information of the 3D region based on the three-dimensional feature of the 3D region.

In some embodiments, feature extraction is performed on the first image and the second image through image processing, to obtain the image feature of the first image and the image feature of the second image. The image feature of the first image and the image feature of the second image are fused based on the distance between the first camera and the second camera and the focal lengths of the first camera and the second camera, to obtain a three-dimensional feature of the 3D region and generate the three-dimensional layout information of the 3D region, such as a distance and a three-dimensional pose of at least one real object in the 3D region relative to the device where the first camera/the second camera/the first camera and the second camera are located, including annotation information (such as a name) corresponding to the at least one real object in the 3D region. Through feature extraction performed on the images, the features of two pictures may be combined to obtain a three-dimensional feature, and three-dimensional layout information of the 3D region may be determined based on the three-dimensional feature. The three-dimensional layout information obtained in this way is more accurate than the two-dimensional information.

In the embodiments of this application, the image feature of the first image and the image feature of the second image are fused to obtain the three-dimensional feature of the 3D region. The three-dimensional feature is configured for characterizing the spatial information of the 3D region. The spatial information herein may be understood as information included in space. In other words, the three-dimensional feature can reflect information of the 3D region in space. Therefore, three-dimensional layout information of the 3D region may be generated based on the three-dimensional feature.

In some embodiments, the foregoing device is a head-mounted display device. The method further includes: constructing a virtual scene or a virtual object adapted to the 3D region based on the three-dimensional layout information; and displaying the virtual scene or the virtual object in the 3D region. The virtual scene is a virtual and unreal scene picture, such as a virtual grassland, a virtual forest, or a virtual house. The virtual scene may be a simulation environment for the real world, or may be a semi-simulation and semi-fiction environment, and may also be a purely fictional environment. the virtual scene may be a two-dimensional virtual scene, may be a 2.5-dimensional virtual scene, or may be a three-dimensional virtual scene. This is not limited in this embodiment of this application. The virtual object may be a virtual creature, and the virtual creature may be in the form of a human, or may be in another form of an animal or a cartoon. This is not limited in the embodiments of this application. The virtual object may further be a virtual item, such as a virtual toy, virtual flowers and plants, or a virtual book. In some embodiments, the virtual object may be a three-dimensional model created based on a skeletal animation technology. In the embodiments of this application, the head-mounted display device is configured to construct the virtual scene or the virtual object based on the three-dimensional layout information, thereby implementing construction of the virtual scene or the virtual object during collection of an image, so that when the user uses the head-mounted device, the head-mounted device can quickly construct the virtual scene or the virtual object through a picture collected by a camera, and project the virtual scene or the virtual object to the user for viewing, thereby helping improve user experience. Certainly, in the embodiments of this application, the first camera and the second camera are arranged on the same device, and the relative positions of the first camera and the second camera are fixed, which not only helps save image collection costs, but also improves image collection efficiency to a certain extent, and further improves generation efficiency of the three-dimensional feature of the 3D region.

In some embodiments, a picture of the virtual scene may be projected and displayed on a real object in the 3D region after a size parameter and a color parameter are adjusted based on the three-dimensional layout information of the 3D region. As shown in FIG. 5, the virtual scene 16 may be projected and displayed on a wall based on a shape and a size of at least one wall in the 3D region, and the picture of the virtual scene 16 coincides with the wall of the 3D region and just covers the wall of the 3D region.

In some embodiments, the virtual object may be projected and displayed in the 3D region based on the three-dimensional layout information of the 3D region. As shown in FIG. 5, a virtual pet 17 is displayed in the 3D region based on three-dimensional layout information corresponding to a floor in the 3D region. The virtual pet 17 appears to be standing on the floor, and soles of feet of the virtual pet are just attached to the floor. Therefore, the virtual pet does not appear to be suspended in the air or extends below the floor. As shown in FIG. 5, an animation of a projected virtual bouncy ball 18 may show that the virtual bouncy ball 18 falls from the air, touches a real floor, and bounces off the floor.

The virtual scene or the virtual object is displayed in the real 3D region, and the virtual scene or the virtual object is combined with the real scene environment, thereby improving the sense of reality of the virtual scene or the virtual object and improving visual experience of the user.

Based on the above, in the technical solutions provided in the embodiments of this application, the same 3D region is photographed at the same time by using the first camera and the second camera, to obtain images of the same 3D region photographed from two different angles at the same time. To be specific, the images of the 3D region are obtained through a binocular camera, and a three-dimensional spatial layout of an object in the 3D region is determined based on the images. Compared with two-dimensional layout information, the accuracy of the layout information of the 3D region is improved.

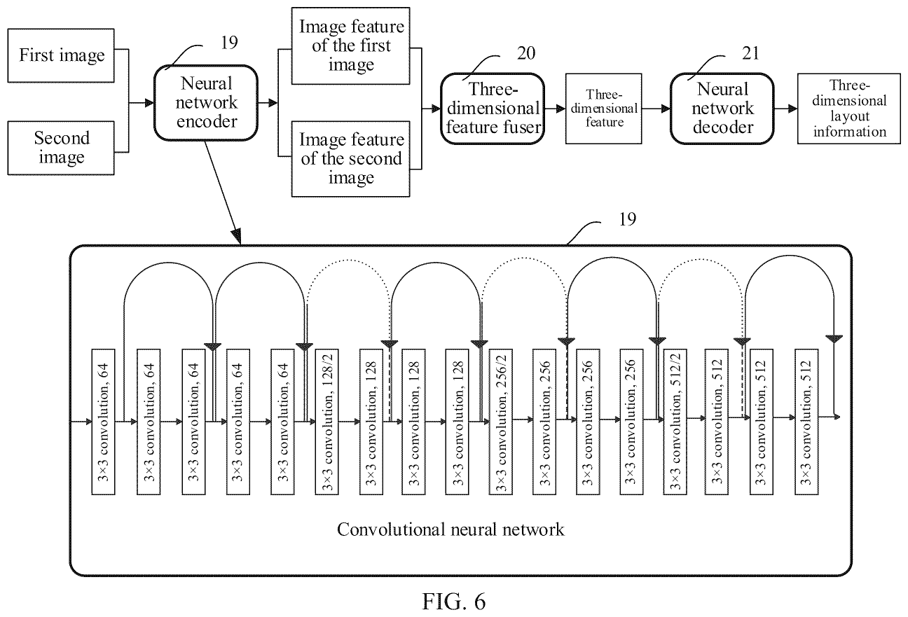

In some possible implementations, as shown in FIG. 6, the three-dimensional layout information is obtained by a three-dimensional layout estimation model. The three-dimensional layout estimation model includes a neural network encoder 19, a three-dimensional feature fuser 20, and a neural network decoder 21.

The neural network encoder 19 is configured to generate the image feature of the first image and the image feature of the second image.

For the process of generating the image feature of the first image and the image feature of the second image through the neural network encoder, reference may be made to the following formula:

fₗ=E(Iₗ)

fᵣ=E(Iᵣ)
where Iₗ represents the first image, Iᵣ represents the second image, fₗ represents the image features of the first image, and fᵣ represents the image features of the second image.

In some embodiments, the neural network encoder is a ResNet-18 structure. As shown in FIG. 6, the neural network encoder 19 removes the last fully connected layer (i.e. an FC layer) and Softmax layer to retain only a convolutional neural network. In some embodiments, a convolutional kernel size of the neural network encoder may be 3×3, and a convolutional kernel of the neural network encoder may also be of another size. The convolutional kernel size of the neural network encoder is not specifically limited in the embodiments of this application.

The three-dimensional feature fuser 20 is configured to fuse the image feature of the first image and the image feature of the second image based on the relative position between the first camera and the second camera and the photographing parameter of each of the first camera and the second camera, to generate the three-dimensional feature of the 3D region.

In some embodiments, for the process of generating the three-dimensional feature f_{3d} of the 3D region, reference may be made to the following formula:

f_{3d}=F(fₗ,fᵣ)

In some embodiments, the three-dimensional feature fuser includes a first neural network and a second neural network, the first neural network being a neural network designed based on a binocular disparity estimation principle, and the second neural network being a recurrent neural network. The first neural network is configured to fuse the image feature of the first image and the image feature of the second image to generate a fused feature of the first image and the second image, the fused feature of the first image and the second image being configured for comprehensively characterizing the first image and the second image; and the second neural network being configured to generate the three-dimensional feature of the 3D region based on the fused feature of the first image and the second image.

In some embodiments, the first neural network is a cost-volume network designed based on the binocular disparity estimation principle. The cost-volume network represents a left-right disparity search space in a stereo matching problem, which is configured to measure a similarity between two views in binocular disparity estimation. In some embodiments, the second neural network is a gate recurrent unit (GRU). The GRU can better capture a dependency in time series data having a large interval, and may solve a gradient problem in long-term memory and back propagation. In some embodiments, the first neural network generates a fused feature of the first image and the second image, which is divided into a plurality of feature blocks (such as 9 feature blocks) that are inputted into the second neural network in sequence. The second neural network generates and saves an implicit vector by learning features of the inputted feature blocks. A new feature block is inputted, and a feature of the new feature block is fused with the saved implicit vector to obtain an updated implicit vector. Until the features of all the feature blocks are learned, a three-dimensional feature of the 3D region is generated. The three-dimensional feature obtained in this way may have an association between different regions and has a global feature, thereby improving the overall coordination and layout rationality of the finally obtained three-dimensional layout information, i.e., improving the accuracy of the layout information of the 3D region.

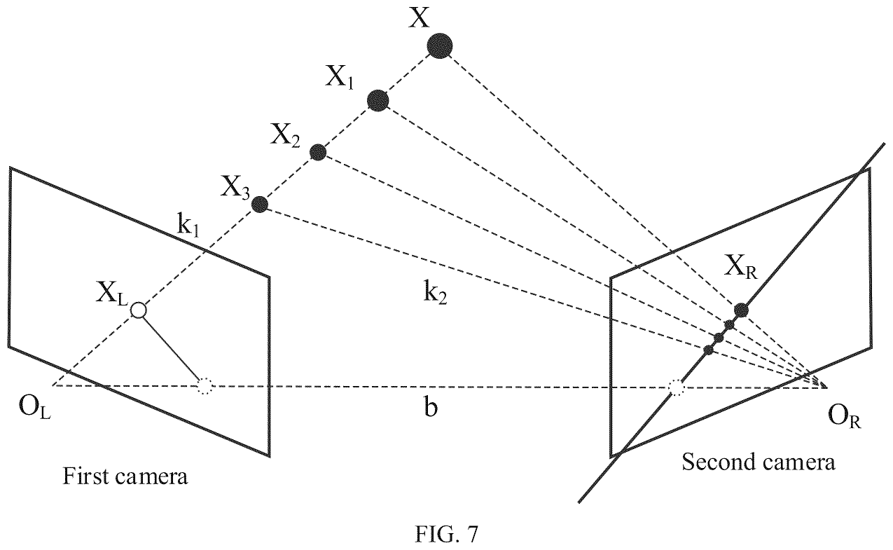

The binocular disparity estimation is also referred to as binocular depth estimation or stereo matching. In some embodiments, as shown in FIG. 7, a disparity map composed of a disparity value d (for example, a disparity value d2-k1-k2 corresponding to a pixel X₂) corresponding to each pixel in a reference image (the reference image may be a first image or a second image) may be obtained through binocular disparity estimation. The disparity value is a difference between a distance of a corresponding point position of a point in a three-dimensional scene in the first image relative to the first camera and a distance of a corresponding point position of the point in the second image relative to the second camera. When a distance b between the first camera and the second camera and a focal length f of the first camera and the second camera are given, a depth d corresponding to at least one pixel in the reference image may be automatically calculated from the disparity map. For calculation of the depth d, reference may be made to the following formula:

$$\hat{d} = bf / d$$

The neural network decoder 21 is configured to generate the three-dimensional layout information of the 3D region based on the three-dimensional feature of the 3D region. In some embodiments, the neural network decoder is composed of the convolutional neural network and the FC layer.

In some embodiments, for the process of generating the three-dimensional layout information L of the 3D region, reference may be made to the following formula:

L=D(f_{3d})

In the above implementation, the entire model is designed end to end, and the three-dimensional layout information obtained by performing image processing and learning on the first image and the second image through the neural network model can reduce interference of illumination and color information of the image on results, thereby further improving the accuracy of the layout information of the 3D region.

In some embodiments, in a case that each 3D region is only a partial region of the scene, the method further includes the following operations:

1. Obtain three-dimensional layout information respectively corresponding to a plurality of different 3D regions.

The three-dimensional layout information respectively corresponding to different 3D regions may refer to three-dimensional layout information of the 3D region at different angles.

2. Obtain the three-dimensional layout information of the entire scene based on the three-dimensional layout information respectively corresponding to the plurality of different 3D regions.

If the 3D region is relatively large, the three-dimensional layout information corresponding to different region parts may be determined from a plurality of angles, and then the three-dimensional layout information respectively corresponding to the plurality of different 3D regions are combined to obtain the three-dimensional layout information of the scene seen from the plurality of angles, i.e., obtain the three-dimensional layout information of the entire scene. The three-dimensional layout information of the entire scene may be displayed in the form of a panoramic image, a dynamic image, or a video.

In some embodiments, the combination of the three-dimensional layout information respectively corresponding to the plurality of different 3D regions includes the following: When a certain 3D region is photographed, the 3D region and a junction of the 3D region and an adjacent 3D region thereof are also photographed. In other words, a first image and a second image of the 3D region include the junction of the 3D region and the adjacent 3D region thereof. After the first image and the second image of the 3D region are obtained, three-dimensional layout information of the 3D region and three-dimensional layout information of the junction of the 3D region and the adjacent 3D region thereof are generated (the three-dimensional layout information of the junction may also be included in the three-dimensional layout information corresponding to the 3D region). Then the three-dimensional layout information of the plurality of 3D regions is fused based on the three-dimensional layout information of at least one 3D region and the three-dimensional layout information of the junction of at least one region, to obtain the three-dimensional layout information of the entire scene.

For example, the entire 3D region is a room, and the room is divided into four regions: a southeast region, a northeast region, a southwest region, and a northwest region. When a first image and a second image of the southeast region are photographed, partial regions of the northeast region and the southwest region close to the southeast region are also photographed. When three-dimensional layout information of the southeast region is generated, three-dimensional layout information of a junction of the southeast region and an adjacent region is also generated at the same time (the three-dimensional layout information of the junction includes three-dimensional layout information of the partial regions of the northeast region and the southwest region close to the southeast region), and the three-dimensional layout information of the junction and the three-dimensional layout information of the southeast region are three-dimensional layout information as a whole, and jointly constitute the three-dimensional layout information corresponding to the southeast region. After the three-dimensional layout information respectively corresponding to the southeast region, the northeast region, the southwest region, and the northwest region is generated, the three-dimensional layout information corresponding to at least one region is fused and spliced with the three-dimensional layout information of the junction of the region to obtain the three-dimensional layout information of the entire room.

In the embodiment, the three-dimensional layout information respectively corresponding to different 3D regions is obtained to obtain more comprehensive three-dimensional layout information of the entire scene from more angles, thereby improving comprehensiveness and richness of the obtained three-dimensional layout information.

An apparatus embodiment of this application is described below, which may be configured for performing the method embodiment of this application. For details not disclosed in the apparatus embodiment of this application, reference is made to the method embodiment of this application.

FIG. 8 is a block diagram of an apparatus for determining three-dimensional layout information according to an embodiment of this application. The apparatus has a function of implementing an example of the foregoing method for determining three-dimensional layout information. The function may be implemented by hardware, or may be implemented by hardware executing corresponding software. The apparatus may be the computer device described above, or may be arranged on the computer device. The apparatus 800 may include an image obtaining module 810 and an information generation module 820.

The image obtaining module 810 is configured to obtain a first image and a second image obtained by photographing a same 3D region by a first camera and a second camera simultaneously.

The information generation module 820 is configured to generate three-dimensional layout information of the 3D region based on a relative position between the first camera and the second camera, a photographing parameter of each of the first camera and the second camera, the first image, and the second image, the three-dimensional layout information being configured for characterizing a three-dimensional spatial layout of at least one real object in the 3D region.

In some embodiments, the information generation module 820 is configured to:
generate an image feature of the first image and an image feature of the second image;
fuse the image feature of the first image and the image feature of the second image based on the relative position between the first camera and the second camera and the photographing parameter of each of the first camera and the second camera, to generate a three-dimensional feature of the 3D region, the three-dimensional feature being configured for characterizing spatial information of the 3D region; and
generate the three-dimensional layout information of the 3D region based on the three-dimensional feature of the 3D region.

In some embodiments, the three-dimensional layout information is obtained by a three-dimensional layout estimation model, the three-dimensional layout estimation model including a neural network encoder, a three-dimensional feature fuser, and a neural network decoder;
the neural network encoder being configured to generate the image feature of the first image and the image feature of the second image;
the three-dimensional feature fuser being configured to fuse the image feature of the first image and the image feature of the second image based on the relative position between the first camera and the second camera and the photographing parameter of each of the first camera and the second camera, to generate the three-dimensional feature of the 3D region; and
the neural network decoder being configured to generate the three-dimensional layout information of the 3D region based on the three-dimensional feature of the 3D region.

In some embodiments, the three-dimensional feature fuser includes a first neural network and a second neural network, the first neural network being a neural network designed based on a binocular disparity estimation principle, and the second neural network being a recurrent neural network;
the first neural network being configured to fuse the image feature of the first image and the image feature of the second image to generate a fused feature of the first image and the second image, the fused feature of the first image and the second image being configured for comprehensively characterizing the first image and the second image; and
the second neural network being configured to generate the three-dimensional feature of the 3D region based on the fused feature of the first image and the second image.

In some embodiments, the three-dimensional layout information of the 3D region includes three-dimensional pose information and annotation information of the at least one real object in the 3D region.

In some embodiments, the first camera and the second camera are arranged on a same device, and the relative positions of the first camera and the second camera are fixed.

In some embodiments, the device is a head-mounted display device; and The apparatus 800 further includes a construction module and a display module.

The construction module is configured to construct a virtual scene or a virtual object adapted to the 3D region based on the three-dimensional layout information.

The display module is configured to display the virtual scene or the virtual object in the 3D region.

In some embodiments, the relative position includes a distance, and the photographing parameter includes a focal length.

Based on the above, in the technical solutions provided in the embodiments of this application, the same 3D region is photographed at the same time by using the first camera and the second camera, to obtain images of the same 3D region photographed from two different angles at the same time. To be specific, the images of the 3D region are obtained through a binocular camera, and a three-dimensional spatial layout of an object in the 3D region is determined based on the images. Compared with two-dimensional layout information, the accuracy of the layout information of the 3D region is improved.

When the apparatus provided in the foregoing embodiment implements the functions of the apparatus, only division of the foregoing functional modules is used as an example for description. In a practical application, the functions may be completed by different functional modules as required. To be specific, an internal structure of a device is divided into different functional modules to complete all or part of the functions described above. In addition, the apparatus provided in the foregoing embodiment belongs to the same idea as the method embodiment. For details of the specific implementation process thereof, reference is made to the method embodiment. Details are not described herein again.

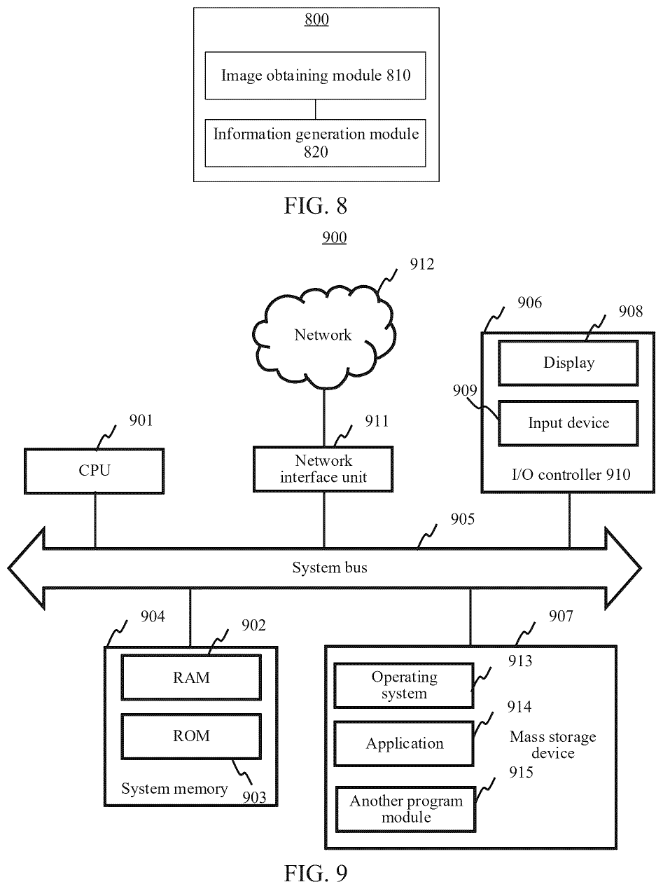

FIG. 9 is a structural block diagram of a computer device according to an embodiment of this application. The computer device is configured to implement the method for determining three-dimensional layout information provided in the foregoing embodiments. Specifically, the computer device 900 includes a central processing unit (CPU) 901, a system memory 904 including a random access memory (RAM) 902 and a read-only memory (ROM) 903, and a system bus 905 connecting the system memory 904 to the CPU 901. The computer device 900 further includes a basic input/output (I/O) system 906 that helps information transmission between various devices in a computer, and a mass storage device 907 configured to store an operating system 913, an application program 914, and another program module 915.

The basic I/O system 906 includes a display 908 configured to display information and an input device 909 such as a mouse or a keyboard for a user to input information. The display 908 and the input device 909 are both connected to the CPU 901 through an I/O controller 910 connected to the system bus 905. The basic I/O system 906 may further include the I/O controller 910 to be configured to receive and process inputs from a plurality of other devices such as a keyboard, a mouse, and an electronic stylus. Similarly, the I/O controller 910 further provides an output to a display screen, a printer, or another type of output device.

The mass storage device 907 is connected to the CPU 901 by using a mass storage controller (not shown) connected to the system bus 905. The mass storage device 907 and a computer-readable medium associated with the mass storage device provide non-volatile storage for the computer device 900. In other words, the mass storage device 907 may include a computer-readable medium (not shown) such as a hard disk or a compact disc ROM (CD-ROM) drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable ROM (EPROM), an electrically erasable programmable ROM (EEPROM), a flash memory or another solid-state memory, a CD-ROM, a digital video disc (DVD) or another optical memory, a tape cartridge, a magnetic tape, a magnetic disk memory, or another magnetic storage device. Certainly, a person skilled in the art may learn that the computer storage medium is not limited to the foregoing several types. The system memory 904 and the mass storage device 907 may be collectively referred to as a memory.

According to the embodiments of this application, the computer device 900 may be further connected to a remote computer on a network for running through a network such as the Internet. In other words, the computer device 900 may be connected to a network 912 through a network interface unit 911 connected to the system bus 905, or may be connected to another type of network or a remote computer system (not shown) through the network interface unit 911.

In an exemplary embodiment, a computer-readable storage medium is further provided. The storage medium has a computer program stored therein, the computer program, when executed by a processor, implementing the foregoing method for determining three-dimensional layout information.

In some embodiments, the computer-readable storage medium may include a ROM, a RAM, a solid state drive (SSD), an optical disc, or the like. The RAM may include a resistive RAM (ReRAM) and a dynamic RAM (DRAM).

In an exemplary embodiment, a computer program product is further provided. The computer program product includes a computer program, the computer program being stored in a computer-readable storage medium. A processor of a computer device reads the computer program from the computer-readable storage medium, and the processor executes the computer program, so that the computer device performs the foregoing method for determining three-dimensional layout information.

“A plurality of” mentioned herein means two or more. The term “and/or” is an association relationship for describing associated objects and represents that three relationships may exist. For example, A and/or B may represent the following three cases: only A exists, both A and B exist, and only B exists. The character “/” generally indicates an “or” relationship between a preceding associated object and a latter associated object.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for determining three-dimensional layout information performed by a computer device and comprising:
obtaining a first image and a second image of a 3D region using a first camera and a second camera simultaneously; and
generating three-dimensional layout information of the 3D region based on a relative position between the first camera and the second camera, a photographing parameter of each of the first camera and the second camera, the first image, and the second image, the three-dimensional layout information being configured for characterizing a three-dimensional spatial layout of at least one real object in the 3D region.

2. The method according to claim 1, wherein the generating three-dimensional layout information of the 3D region based on a relative position between the first camera and the second camera, a photographing parameter of each of the first camera and the second camera, the first image, and the second image comprises:
generating an image feature of the first image and an image feature of the second image;
fusing the image feature of the first image and the image feature of the second image based on the relative position between the first camera and the second camera and the photographing parameter of each of the first camera and the second camera, to generate a three-dimensional feature of the 3D region, the three-dimensional feature being configured for characterizing spatial information of the 3D region; and
generating the three-dimensional layout information of the 3D region based on the three-dimensional feature of the 3D region.

3. The method according to claim 2, wherein the three-dimensional layout information is obtained by a three-dimensional layout estimation model, the three-dimensional layout estimation model comprising a neural network encoder, a three-dimensional feature fuser, and a neural network decoder;
the neural network encoder being configured to generate the image feature of the first image and the image feature of the second image;
the three-dimensional feature fuser being configured to fuse the image feature of the first image and the image feature of the second image based on the relative position between the first camera and the second camera and the photographing parameter of each of the first camera and the second camera, to generate the three-dimensional feature of the 3D region; and
the neural network decoder being configured to generate the three-dimensional layout information of the 3D region based on the three-dimensional feature of the 3D region.

4. The method according to claim 3, wherein the three-dimensional feature fuser comprises a first neural network and a second neural network, the first neural network being a neural network designed based on a binocular disparity estimation principle, and the second neural network being a recurrent neural network;
the first neural network being configured to fuse the image feature of the first image and the image feature of the second image to generate a fused feature of the first image and the second image, the fused feature of the first image and the second image being configured for comprehensively characterizing the first image and the second image; and
the second neural network being configured to generate the three-dimensional feature of the 3D region based on the fused feature of the first image and the second image.

5. The method according to claim 1, wherein the three-dimensional layout information of the 3D region comprises three-dimensional pose information and annotation information of the at least one real object in the 3D region.

6. The method according to claim 1, wherein the first camera and the second camera are arranged on a same device with predefined relative positions of the first camera and the second camera.

7. The method according to claim 1, wherein the method further comprises:
constructing a virtual scene or a virtual object adapted to the 3D region based on the three-dimensional layout information; and
displaying the virtual scene or the virtual object in the 3D region.

8. The method according to claim 1, wherein the relative position comprises a distance, and the photographing parameter comprises a focal length.

9. A computer device, comprising a processor and a memory, the memory having computer programs stored therein, the computer programs, when executed by the processor, causing the computer device to implement a method for determining three-dimensional layout information including:
obtaining a first image and a second image of a 3D region using a first camera and a second camera simultaneously; and
generating three-dimensional layout information of the 3D region based on a relative position between the first camera and the second camera, a photographing parameter of each of the first camera and the second camera, the first image, and the second image, the three-dimensional layout information being configured for characterizing a three-dimensional spatial layout of at least one real object in the 3D region.

10. The computer device according to claim 9, wherein the generating three-dimensional layout information of the 3D region based on a relative position between the first camera and the second camera, a photographing parameter of each of the first camera and the second camera, the first image, and the second image comprises:
generating an image feature of the first image and an image feature of the second image;
fusing the image feature of the first image and the image feature of the second image based on the relative position between the first camera and the second camera and the photographing parameter of each of the first camera and the second camera, to generate a three-dimensional feature of the 3D region, the three-dimensional feature being configured for characterizing spatial information of the 3D region; and
generating the three-dimensional layout information of the 3D region based on the three-dimensional feature of the 3D region.

11. The computer device according to claim 10, wherein the three-dimensional layout information is obtained by a three-dimensional layout estimation model, the three-dimensional layout estimation model comprising a neural network encoder, a three-dimensional feature fuser, and a neural network decoder;
the neural network encoder being configured to generate the image feature of the first image and the image feature of the second image;
the three-dimensional feature fuser being configured to fuse the image feature of the first image and the image feature of the second image based on the relative position between the first camera and the second camera and the photographing parameter of each of the first camera and the second camera, to generate the three-dimensional feature of the 3D region; and
the neural network decoder being configured to generate the three-dimensional layout information of the 3D region based on the three-dimensional feature of the 3D region.

12. The computer device according to claim 11, wherein the three-dimensional feature fuser comprises a first neural network and a second neural network, the first neural network being a neural network designed based on a binocular disparity estimation principle, and the second neural network being a recurrent neural network;
the first neural network being configured to fuse the image feature of the first image and the image feature of the second image to generate a fused feature of the first image and the second image, the fused feature of the first image and the second image being configured for comprehensively characterizing the first image and the second image; and
the second neural network being configured to generate the three-dimensional feature of the 3D region based on the fused feature of the first image and the second image.

13. The computer device according to claim 9, wherein the three-dimensional layout information of the 3D region comprises three-dimensional pose information and annotation information of the at least one real object in the 3D region.

14. The computer device according to claim 9, wherein the first camera and the second camera are arranged on a same device with predefined relative positions of the first camera and the second camera.

15. The computer device according to claim 9, wherein the method further comprises:
constructing a virtual scene or a virtual object adapted to the 3D region based on the three-dimensional layout information; and
displaying the virtual scene or the virtual object in the 3D region.

16. A non-transitory computer-readable storage medium, having computer programs stored therein, the computer programs, when executed by a processor of a computer device, causing the computer device to implement a method for determining three-dimensional layout information including:
obtaining a first image and a second image of a 3D region using a first camera and a second camera simultaneously; and
generating three-dimensional layout information of the 3D region based on a relative position between the first camera and the second camera, a photographing parameter of each of the first camera and the second camera, the first image, and the second image, the three-dimensional layout information being configured for characterizing a three-dimensional spatial layout of at least one real object in the 3D region.

17. The non-transitory computer-readable storage medium according to claim 16, wherein the generating three-dimensional layout information of the 3D region based on a relative position between the first camera and the second camera, a photographing parameter of each of the first camera and the second camera, the first image, and the second image comprises:
generating an image feature of the first image and an image feature of the second image;
fusing the image feature of the first image and the image feature of the second image based on the relative position between the first camera and the second camera and the photographing parameter of each of the first camera and the second camera, to generate a three-dimensional feature of the 3D region, the three-dimensional feature being configured for characterizing spatial information of the 3D region; and
generating the three-dimensional layout information of the 3D region based on the three-dimensional feature of the 3D region.

18. The non-transitory computer-readable storage medium according to claim 16, wherein the three-dimensional layout information of the 3D region comprises three-dimensional pose information and annotation information of the at least one real object in the 3D region.

19. The non-transitory computer-readable storage medium according to claim 16, wherein the first camera and the second camera are arranged on a same device with predefined relative positions of the first camera and the second camera.

20. The non-transitory computer-readable storage medium according to claim 16, wherein the method further comprises:
constructing a virtual scene or a virtual object adapted to the 3D region based on the three-dimensional layout information; and
displaying the virtual scene or the virtual object in the 3D region.
